(19) United States
(12) Patent Application Publication
(10) Pub. No.: US 2004/0142668 A1
(43) Pub. Date: Jul. 22, 2004

(54) Systems and methods for transmitting a radio signal

(76) Inventor: David Ge, Potomac, MD (US)

Correspondence Address: CAHN & SAMUELS LLP, 2000 P STREET NW, SUITE 200, WASHINGTON, DC, 20036, US

(21) Appl. No.: 10/754,568

(22) Filed: Jan. 12, 2004

Related U.S. Application Data
(60) Provisional application No. 60/438,991, filed on Jan. 10, 2003.

(51) Int. Cl. H01Q 11/12

(52) U.S. Cl. 455/127.1; 455/522

(57) ABSTRACT

Disclosed are systems and methods for transmitting a signal. An exemplary system includes a circuit for a system having a signal source, an antenna, and a cable coupled to the signal source and the antenna. The circuit includes an amplifier having an input for coupling to the cable, and output for coupling to the antenna, and a control input. The amplifier varies output power responsive to a signal on the control input. A detector detects a DC bias on the cable. The detector has an output coupled to the control input of the amplifier.

This application claims the benefit of U.S. Patent Application No. 60/438,991 filed on Jan. 10, 2003, which is hereby incorporated by reference.

### BACKGROUND OF THE INVENTION

1. Technical Field

This invention relates generally to systems and methods for transmitting a radio signal and, more particularly, to transmitting a radio signal with a selectable transmit power.

2. Description of Related Art

In wireless applications, every system presents its own set of considerations. Different site environments magnify technical differences between different hardware. For example, in wireless local area network (WLAN) applications, maximizing signal efficiencies remain somewhat of an art dictated by particularities of geography, man made structures, hardware, weather, etc. In some instances, a single preset transmit power does not meet the requirements of the application and adjustment of transmit power is desirable.

When a WLAN is setup between remote users and a central station, the designer needs to select bi-directional amplifiers that have particular output strengths to provide for sufficient signal strength to cover the distance between the user and the central station. There have been attempts made by others to provide some flexibility for bi-directional amplifiers that include a dip switch adjustment on the bi-directional amplifier itself that may be set to provide the desired output. The problem is that if the user wishes to change the output level because of interference issues or other reasons, they would have to gain access to the bi-directional amplifier to change the settings or swap out the bi-directional amplifier with a new one. Neither of these alternatives is efficient or convenient to be done with any frequency.

Notwithstanding the usefulness of the above-described approaches, a need still exists for adjusting the transmission power of the transmitted signal by the user without making a physical change at the bi-directional amplifier.

### SUMMARY OF THE INVENTION

It is an object of the present invention to provide systems and methods for varying transmit power in a radio system.

To achieve this and other objects of the present invention, the invention contemplates a circuit for a system having a signal source, an antenna, and a cable coupled to the signal source and the antenna, the circuit comprising an amplifier having a first input for coupling to the cable, an output for coupling to the antenna, and a second input, wherein the amplifier varies gain responsive to a signal on the second input; and a detector having an input for coupling to the cable, the detector having an output coupled to the second input of the amplifier, wherein in the amplifier is responsive to a first signal on the cable, the first signal including an RF signal, and the detector is responsive to a second signal on the cable.

According to at least one embodiment of the invention, the invention includes an amplifier for a system having a signal source for a transmission signal, an antenna, and a cable coupled to the signal source and the antenna, the amplifier comprising: a sensor having a first input for coupling to the cable and an output, a transmission amplifier module having an input for coupling to the cable and an output for coupling to the antenna, the transmission amplifier module including an attenuator having a first input for receiving the transmission signal from the cable, a second input connected to the output of the sensor, and an output for communicating with the antenna; and wherein the attenuator varies the gain of the transmission signal received at the first input responsive to a signal received at the second input from the sensor based on voltage of the signal received at the amplifier to produce a desired output power level for the transmission signal.

According to at least one embodiment of the invention, the invention includes a power injector for use in a system having a signal source, an amplifier, and cable, the power injector comprising: an input in communication with the signal source, an output in communication with the amplifier, an actuator for selecting an output power level, and a voltage regulator in communication with the output and the actuator, the voltage regulator has a plurality of selectable output power levels.

According to at least one embodiment of the invention, the invention includes an bi-directional amplifier in communication with a signal source and an antenna, the bi-directional amplifier comprising: means for switching between receive and transmit modes, means for setting the output power level of a transmission signal based on the voltage of the transmit signal and providing a control signal, means for attenuating the transmit signal based in part on the control signal, and means for amplification of a received signal.

According to at least one embodiment of the invention, the invention includes an amplifier and a power injector together as a kit and as part of a wireless system.

According to at least one embodiment of the invention, the invention includes a method for setting the output power of a radio signal comprising: receiving a desired output level for the transmission, transmitting a signal having a RF component including the signal to be transmitted and a DC component representative of the transmission output level, receiving the signal, amplifying the RF component of the signal, detecting the size of the DC component and providing an attenuation control signal, attenuating the RF component of the signal to a level such that when the RF signal is transmitted it will be transmitted at the desired output level, and transmitting the RF component of the signal.

Given the following enabling description of the drawings, the invention should become evident to a person of ordinary skill in the art.

### BRIEF DESCRIPTION OF THE DRAWINGS

The present invention is described with reference to the accompanying drawings. In the drawings, like reference numbers indicate identical or functionally similar elements. The use of cross-hatching and shading within the drawings is not intended as limiting the type of materials that may be used to manufacture the invention.

FIG. 1 is a diagram of a system employing an amplifier circuit in accordance with the present invention.

FIG. 2 is a diagram emphasizing a portion of the system shown in FIG. 1.

FIG. 3 is a diagram emphasizing another portion of the system shown in FIG. 1.

FIG. 4 is a diagram emphasizing a portion of the circuitry shown in FIG. 3.

FIG. 5 is a diagram emphasizing a portion of the circuitry shown in FIG. 4.

FIG. 6 is a diagram of circuitry used with that of FIG. 3.

FIG. 7 is a diagram of circuitry used with that of FIG. 3.

FIG. 8 is a diagram emphasizing an aspect of a system in accordance with another embodiment of the invention.

FIG. 9 is a diagram emphasizing a portion of the circuitry shown in FIG. 8.

FIG. 10 is a diagram emphasizing another portion of the circuitry show in FIG. 8.

FIG. 11 is a diagram emphasizing another portion of the circuitry shown in FIG. 8.

FIG. 12 is a diagram emphasizing another portion of the circuitry shown in FIG. 8.

### DETAILED DESCRIPTION OF THE PREFERRED EMBODIMENTS

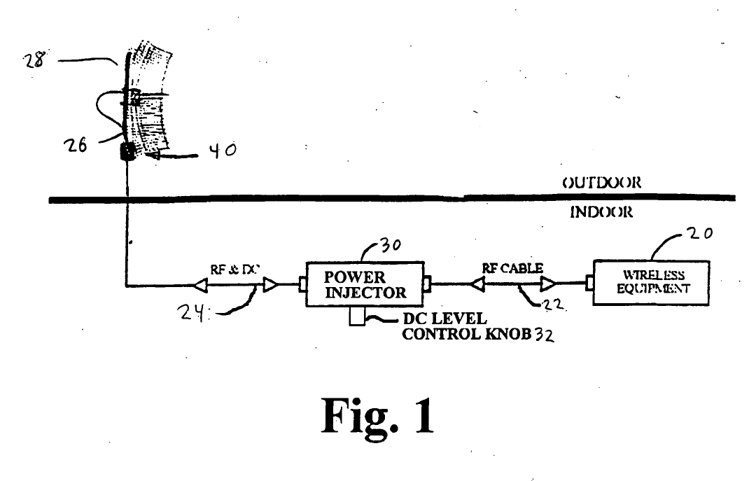

The invention is for use as part of a system that typically includes wireless equipment 20 such as a radio modem for transmitting and receiving communication, a power injector 30, an amplifier 40, an antenna 28, and cabling 22, 24, 26 connecting each of these components together as illustrated, for example, in FIG. 1. The system may be in a Wireless Local Area Network (WLAN), or Wireless Local Loop (WLL). The system may be applied to Wireless Internet Access (WIA) point-to-point and point-to-multipoint applications. This invention allows the user of the wireless equipment 20 to set the level of output power given to a transmission signal by setting the level preferably through the power injector 30 that sets a voltage for the transmission on the cable that is detected by the amplifier 40 that then adjusts the output power of the transmission based on the set voltage. The amplifier 40 preferably is a bi-directional amplifier.

FIG. 1 illustrates the system having a module (or amplifier) 40 in accordance with a first preferred embodiment of the present invention.

A radio modem 20 is connected to send signals to and receive signals from an RF cable 22. The radio modem 20 includes circuitry to implement a Time Division Duplex (TDD) protocol, and to otherwise meet the user's needs.

A power injector 30 passes signals between the cable 22 and a cable 24, and superimposes a DC voltage on the RF signal on the cable 24. The level of the DC voltage is variable by manual manipulation of a control knob 32. The power injector 30 is typically located in a protected environment, such as a shelter or inside the building, and proximate to radio modem 20 or other wireless RF equipment.

The cable 24 communicates signals between the power injector 30 and the module 40. The module 40 amplifies RF signals received from the cable 24, and sends the amplified signal to an antenna 28. The module 40 is powered by the DC voltage on the cable 24. The module 40 is mounted on the pole of antenna 28 on the exterior of a building. The module 40 may be mounted on the pole using any number of means including U-bolts, clamps, etc.

Preferably, the housing for the module 40 is small and waterproof, to provide for direct mounting on the antenna 28. The illustrated embodiment includes a housing having N-type, male, 50 Ohm connectors adapted for quick connection to standard commercially available N-type, female, 50 Ohm connectors disposed on the connecting cables.

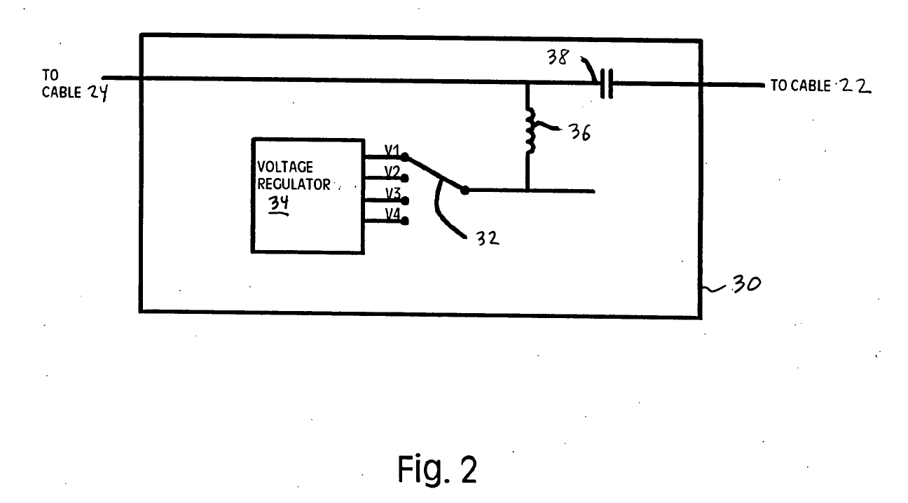

FIG. 2 illustrates the power injector 30 in more detail. A voltage regulator 34 generates four voltages: V1, V2, V3, and V4. In this example, V1 equals 9 volts, V2 equals 10 volts, V3 equals 11 volts, and V4 equals 12 volts. A control knob 32 includes a 4-to-1 switch for connecting (or applying) a selected one of voltages V1, V2, V3, or V4 to the lower terminal of the inductor 36. The voltage regulator 34 and control knob 32 may be designed to provide two or more output power levels.

A capacitor 38 blocks a DC current from passing between the voltage regulator 34 and the cable 22. An inductor 36 blocks the RF signal from passing to the regulator 34 from either cable 22 and/or 24.

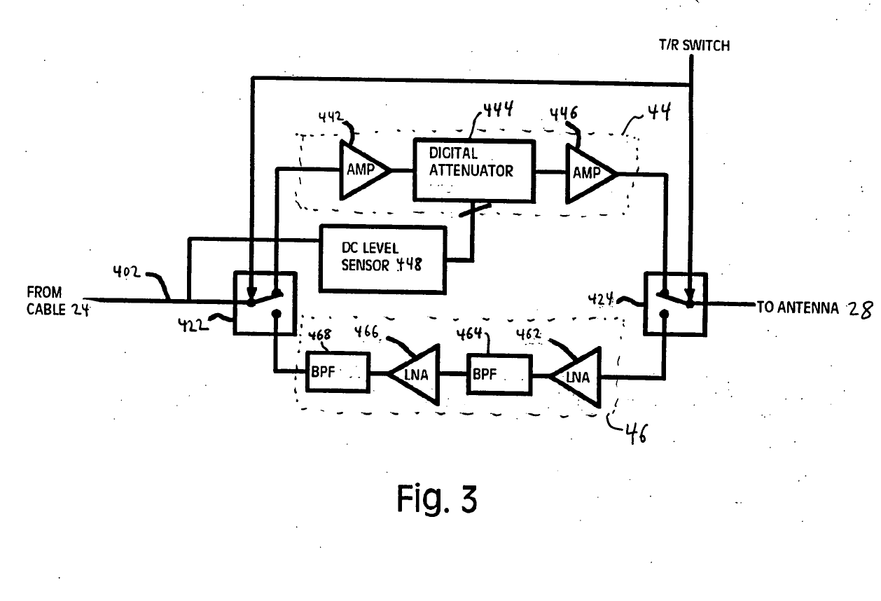

FIG. 3 shows certain circuitry in the module 40. At the time depicted in FIG. 3, the module 40 is in the transmit mode, meaning that a switch 422 transfers a signal on the cable 24 through the transmission amplifier module (or transmission pathway) 44 to the antenna 28 via switch 424. An exemplary embodiment of the transmission amplifier 44 includes a driver amplifier 442 and a power amplifier 446 as illustrated in FIG. 3. An input of digital attenuator 444 receives the output of the driver amplifier 442. The digital attenuator 444 attenuates the received signal from the driver amplifier 442 as dictated by a control input (or signal) from a DC level sensor (or detector) 448, and transfers the attenuated signal to the input of the power amplifier 446. The power amplifier 446 transfers an output signal to the antenna 28 via the switch 424.

In the receive mode, the switches 422 and 424 are in the opposite position of that depicted in FIG. 3. An exemplary receive path is illustrated in FIG. 3 and described herein is a receiving amplifier module (or path or means) 46. A low noise amplifier (LNA) 462 receives a signal from the antenna 28, via the switch 424, and transfers an amplified signal to the input of a band pass filter 464. The band pass filter 464 transfers a filtered output to the input of a low noise amplifier 466. The low noise amplifier 466 transfers an amplified signal to the input of a band pass filter 468. The band pass filter 468 transfers the filter output to the cable 24 via the switch 422. As one of ordinary skill in the art will appreciate based on this disclosure, a variety of receive circuitry found in bi-directional amplifiers could be used for the receive path 46 in the illustrated bi-directional amplifier.

In other words, the module 40 toggles between a transmitting mode and a receiving mode. In the transmitting mode, the switch 424 operatively connects the amplifier 446 to the antenna 28. In the receiving mode, the switch 424 directs an antenna signal to the receive path 46.

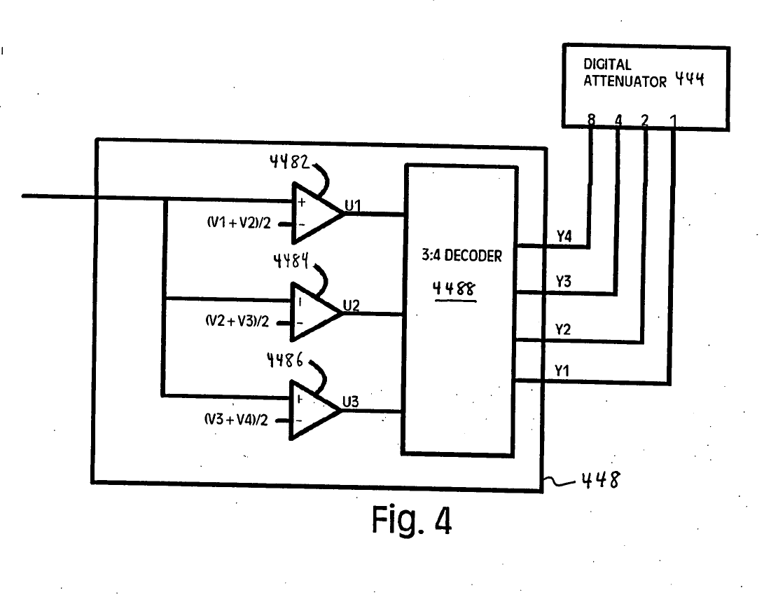

FIG. 4 emphasizes certain circuitry in the DC level sensor 448. The respective + input of each of comparators (means for determining the voltage level of the signal being transmitted) 4482, 4484, 4486 receives a signal from the cable 24.

The − input of the comparator 4482 receives a reference voltage substantially equal to (V1+ V2)2, causing the comparator 4482 to apply a digital output U1 to a 3:4 decoder 4488 (means for coding a signal to instruct the attenuator 444 the level of attenuation to apply to the signal being transmitted). V1 and V2 are two of the user selectable voltages sent from the power injector 30, as illustrated in FIG. 2.

The − input of the comparator 4484 receives a reference voltage substantially equal to (V2+ V3)2, causing the comparator 4484 to apply a digital output U2 to the 3:4 decoder 4488. V3 is one of the user selectable voltages sent from the power injector 30, as illustrated in FIG. 2.

The − input of the comparator 4486 receives a reference voltage substantially equal to (V3+ V4)2, causing the comparator 4484 to apply a digital output U3 to the 3:4 decoder 4488. V4 is one of the user selectable voltages sent from the power injector 30, as illustrated in FIG. 2.

Table 1 below shows functionality of the 3:4 decoder 4488. The decoder 4488 produces output (Y1, Y2, Y3, and Y4) as a function of input (U1, U2, and U3).

Table 1 also shows the functionality of the comparators 4482, 4484, 4486. The comparators 4482, 4484, 4486 produce outputs (U1, U2, and U3) as a function of a DC voltage on the cable 24.

TABLE 1

| DC Input | | | | | | | |
|---|---|---|---|---|---|---|---|
| Cable 104 | U1 | U2 | U3 | Y1 | Y2 | Y3 | Y4 |
| V1 | 0 | 0 | 0 | 1 | 0 | 1 | 0 |
| V2 | 1 | 0 | 0 | 1 | 0 | 0 | 1 |
| V3 | 1 | 1 | 0 | 0 | 0 | 1 | 1 |
| V4 | 1 | 1 | 1 | 1 | 1 | 1 | 1 |

One of ordinary skill in the art will appreciate that if a number other than four output power levels are provided for at the power injector 12, that the number of comparators can be scaled up or down to correspond to the number of possible output power levels.

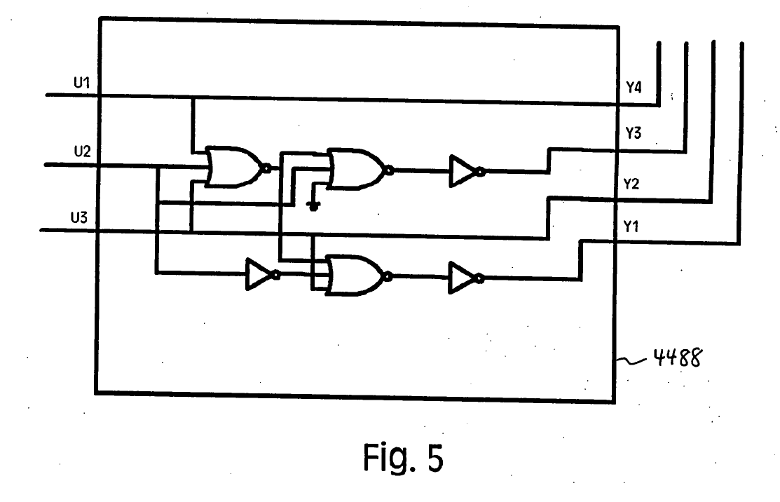

FIG. 5 illustrates an implementation of the 3:4 decoder 4488 using digital logic components that are capable of providing the outputs shown in Table 1 for the inputs representative of the desired output power level.

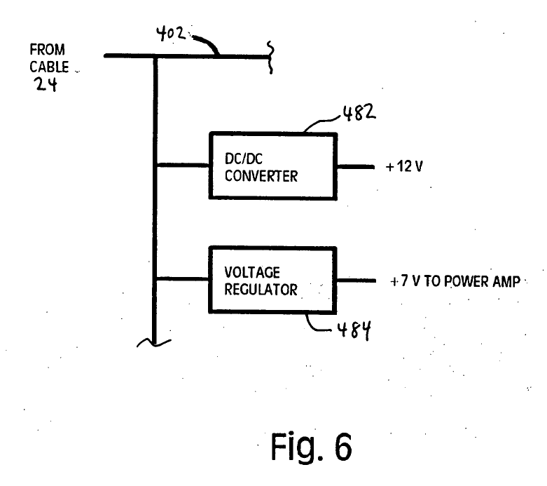

FIG. 6 shows additional circuitry preferably connected to an input node 402 in module 40. A DC/DC converter 482 generates a 12 volt reference, used to generate the references applied to the − inputs of the comparators of FIG. 4. A voltage regulator 484 produces 7 volts for powering the power amplifier 446. In other words, although the DC voltage on node 402 may vary between 9 and 12 volts, the voltage regulator 484 applies a constant voltage of 7 volts to the power amplifier 446.

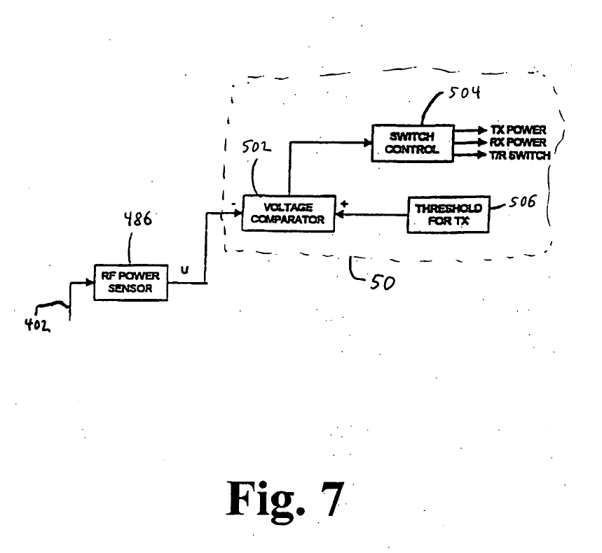

FIG. 7 shows exemplary circuitry for the module 40 to control the switching of switches 422, 424, including an RF power sensor 486 and a switching controller 50 having a voltage comparator 502 connected to the output of the power sensor 486. The voltage comparator 502 provides an output to a switch controller 504 that generates a signal “T/R switch.” The signal “T/R switch” controls whether the switches 422 and 424 are in the transmit position or the receive position. An element 506 provides a transmission voltage threshold to comparator 502. The module 40 thereby switches from transmit to receive mode automatically when the RF power is below the threshold level provided by element 506. The voltage comparator 502, the element 506, and the switch control 504 together can be considered to be a switching controller 50.

The first preferred embodiment of the invention preferably incorporates protective features such as lighting protection circuitry and power surge protective circuitry to prevent damage from operational or environmental anomalies.

Thus, the first preferred embodiment of the invention provides a standardized amplifier that is economical to install, and usable with a broad range of hardware and in a broad range of operational environments.

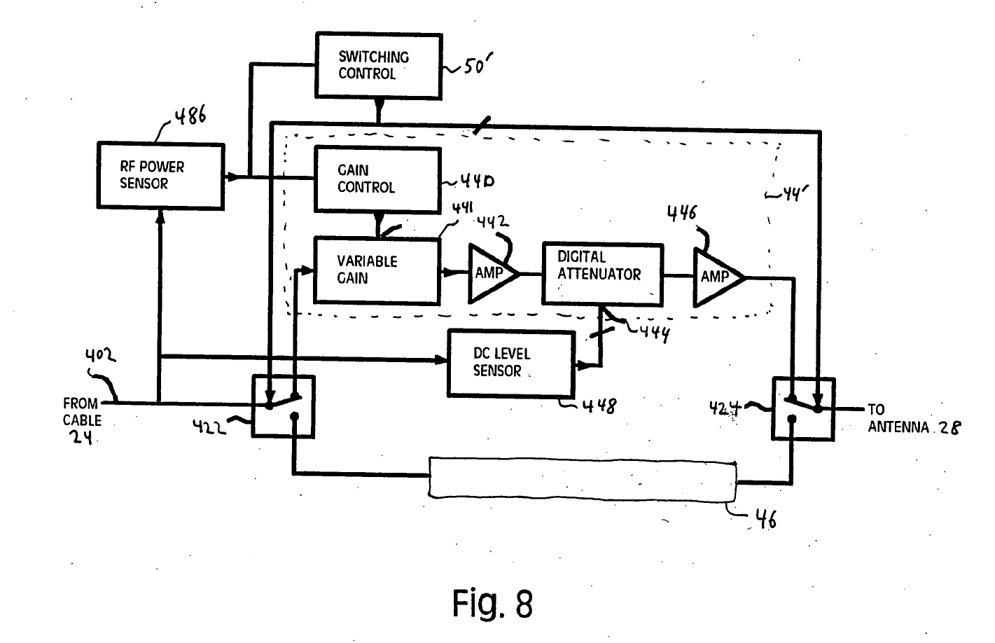

FIG. 8 is a diagram illustrating another exemplary embodiment of the system in accordance with the present invention. The illustrated system includes a variable gain amplifier 441 at the input of amplifier 442 in the transmission amplifier 44. Amplifier 441, RF power sensor 486′, and gain control circuit 440 cooperate to provide a substantially constant input to the amplifier 442.

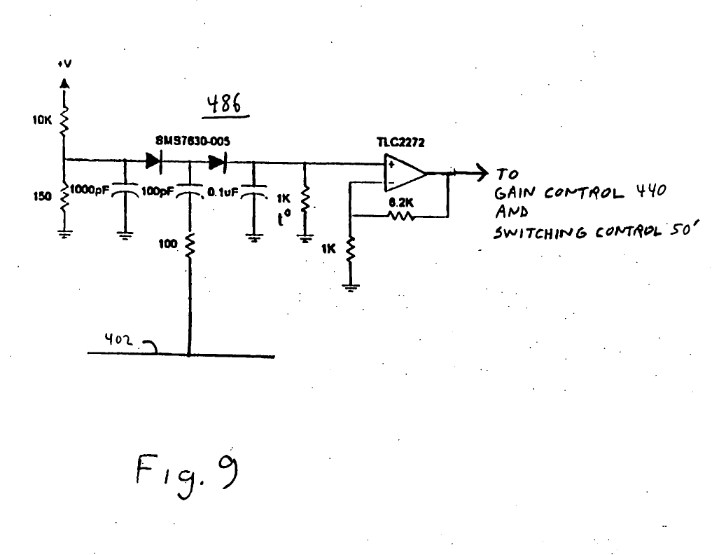

FIG. 9 illustrates a possible implementation of RF power sensor 486′. As one of ordinary skill in the art will appreciate, the implementation illustrated in FIG. 9 may be used for the RF power sensor 486 by eliminating the connection to the gain control 440.

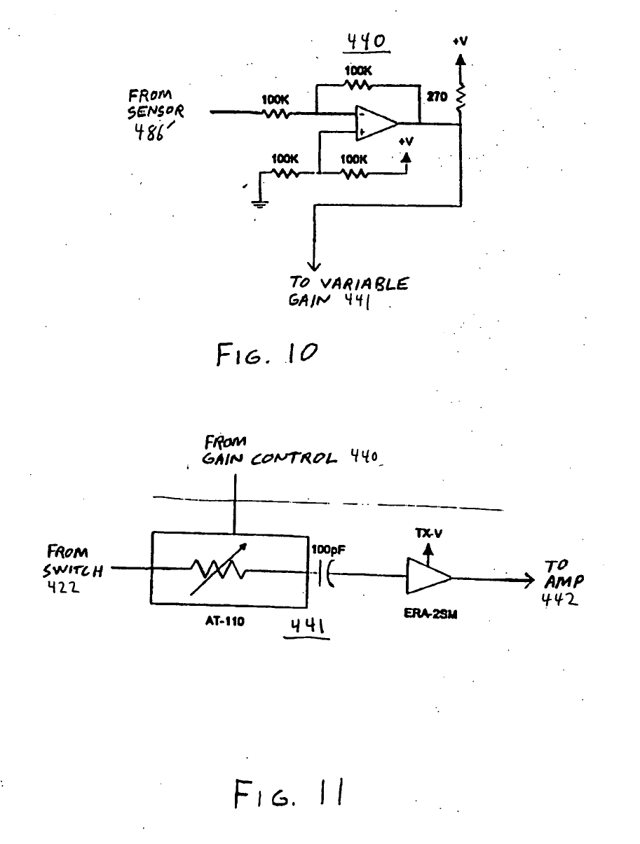

FIG. 10 illustrates a possible implementation of gain control circuit 440, which receives the output of power sensor 486′. Gain control circuit 440 essentially subtracts the output of RF power sensor 486′ from a reference voltage, and applies the subtraction result to a control input of variable gain amplifier 441. Thus, the amplifier 441 remains at a predetermined output power level independent of the RF input power level on input node 402. Alternatively, amplifier 442 may be omitted from this exemplary embodiment.

FIG. 11 illustrates a possible implementation of the variable gain amplifier 441. A variable attenuator AT-110 has a control input that receives the output of the gain control circuit 440 illustrated in FIG. 10.

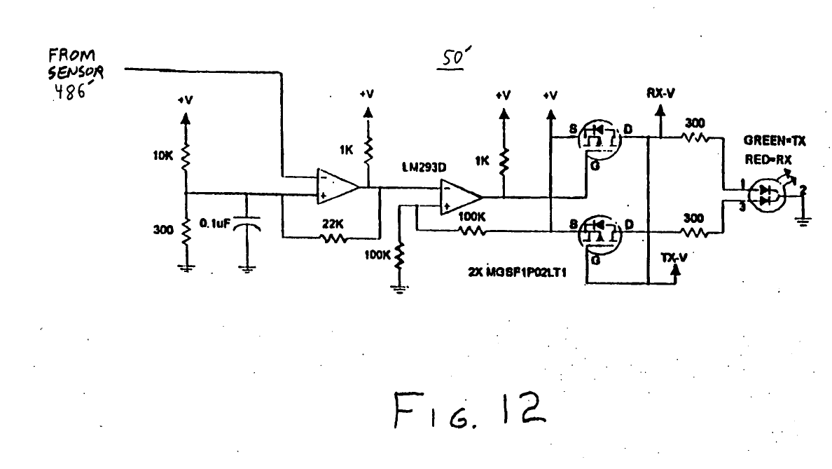

FIG. 12 illustrates a possible implementation of switching control circuit 50′. As one of ordinary skill in the art will appreciate, the implementation illustrated in FIG. 12 may be used for switching control circuit 50. A voltage comparator has a − input connected to the output from the power sensor 486′. The voltage comparator has a + input connected to a 10K:300 resister divider that provides a threshold to distinguish between transmitting and receiving. The circuit 50′ provides a two line output to transmit/receive switches 422 and 428 to switch between the transmit and receive modes depending on the output voltage. The two line output includes the signals RX-V and TX-V shown in FIG. 12. This embodiment thereby switches from transmit to receive mode automatically when RF power is below the threshold level. Alternatively, a single or pair of LED(s) may be included to indicate in which mode the module is operating in.

Circuits to implement RF power sensor 486′, gain control circuit 440, and variable gain amplifier 441 are described in U.S. application Ser. No. 09/524,745, of David Ge, filed Mar. 14, 2000 for SMART AMPLIFIER FOR TIME DIVISION DUPLEX WIRELESS APPLICATIONS, the contents of which are hereby incorporated by reference. These circuits collectively are means for normalizing the signal input into said attenuating means based on the voltage of the transmit signal.

Numerous other embodiments are possible. For example, although a control knob has been illustrated and discussed for the DC level control knob 32 for the power injector 30, there are numerous other ways of effecting power control. For example, power control may be adjusted with dedicated buttons or slides on or connected to the power injector 30, or may be adjusted in response to commands originating from a conventional keyboard connected to a general purpose computer. These various ways for effecting power control are covered by mechanical actuator.

Different exemplary embodiments have been described above with various components that can be grouped into functional groupings. Means for switching between receive and transmit modes includes RF power sensor 486, switching controller 50, 50′, and switches 422, 424. Means for setting the output power level of a transmission signal based on the voltage of the transmit signal and providing a control signal includes the DC level sensor 448. Means for attenuating the transmit signal based in part on the control signal includes the attenuator 444, and under at least one embodiment the transmission amplifier 44. Means for amplification of a received signal includes the receiving amplifier path 46 and its illustrated embodiments. Means for setting a desired output level for the transmission signal include actuator 32 and voltage regulator 34.

Benefits, other advantages, and solutions to problems have been described above with regard to specific examples. The benefits, advantages, solutions to problems, and any element(s) that may cause any benefit, advantage, or solution to occur or become more pronounced are not critical, required, or essential feature or element of any of the claims.

Additional advantages and modifications will readily occur to those skilled in the art. The preferred embodiment of the invention in its broader aspects is therefore not limited to the specific details, representative apparatus, and illustrative examples shown and described. Accordingly, departures may be made from such details without departing from the spirit or the scope of Applicants′ general inventive concept. The preferred embodiment of the invention is defined in the following claims. In general, the words “first,” “second,” etc., employed in the claims do not necessarily denote an order.

As used herein “substantially” is a relative modifier intended to indicate permissible variation from the characteristic so modified. It is not intended to be limited to the absolute value or characteristic which it modifies but rather approaching or approximating such a physical or functional characteristic.

Given the foregoing, it should be apparent that the specific described embodiments are illustrative and not intended to be limiting. Furthermore, variations and modifications to the preferred embodiment of the invention should now be apparent to a person having ordinary skill in the art. These variations and modifications are intended to fall within the scope and spirit of the preferred embodiment of the invention as defined by the following claims.

I claim:

1. An amplifier for a system having a signal source for a transmission signal, an antenna, and a cable coupled to the signal source and the antenna, the amplifier comprising:
a sensor having a first input for coupling to the cable and an output,
a transmission amplifier module having an input for coupling to the cable and an output for coupling to the antenna, said transmission amplifier module including an attenuator having
a first input for receiving the transmission signal from the cable,
a second input connected to the output of said sensor, and
an output for communicating with the antenna; and
wherein said attenuator varies the gain of the transmission signal received at the first input responsive to a signal received at the second input from the sensor based on voltage of the signal received at the amplifier to produce a desired output power level for the transmission signal.

2. The amplifier according to claim 1, wherein said transmission amplifier module further includes
a first amplifier component having an input for receiving the transmission signal and an output connected to said first input of said attenuator,
a second amplifier component having an input connected to said output of said attenuator and an output for coupling to the antenna.

3. The amplifier according to claim 1, wherein said transmission amplifier module further includes
a gain control having an output,
a variable gain amplifier having a first input connected to said output of said gain control, a second input for coupling to the cable, and an output connected to said first input of said attenuator, and
a second amplifier component having an input connected to said output of said attenuator and an output for coupling to the antenna.

4. The amplifier according to claim 1, further comprising:
receiving amplifier module having an input and an output,
a first switch having a port for coupling with the cable, a first conductor connected to said input of said transmission amplifier module, and a second conductor connected to said output of said receiving amplifier module,
a second switch having a port for coupling with the antenna, a first conductor connected to said output of said transmission amplifier module, and a second conductor connected to said input of said receiving amplifier module, and
a switch controller in communication with said first switch and said second switch.

5. The amplifier according to claim 1, wherein said sensor includes
means for determining the voltage level of the signal being transmitted, and
means for coding a signal to instruct said attenuator the level of attenuation to apply to the signal being transmitted.

6. The amplifier according to claim 1, wherein said sensor includes
a decoder connected to said output of said sensor, and
a plurality of comparator components connected in parallel between said input of said sensor and said decoder, and
wherein said comparators output a plurality of signals representative of the voltage level of the signal to be transmitted and said decoder uses signals to code a plurality of control signals for said attenuator.

7. The amplifier according to claim 6, wherein the number of comparator components is one less than the number of output power levels.

8. A kit comprising:
the amplifier of claim 1, and
a power injector including
an input in communication with the signal source,
an output in communication with the amplifier,
an actuator for selecting an output power level, and
a voltage regulator in communication with said output and said actuator, said voltage regulator has a plurality of selectable output power levels.

9. A system comprising:
said kit of claim 8,
a signal source connected to said power injector,
a cable connecting said power injector and said amplifier, and
an antenna connected to said amplifier.

10. A method for setting the output power of a radio signal comprising:
receiving a desired output level for the transmission,
transmitting a signal having a RF component including the signal to be transmitted and a DC component representative of the transmission output level,
receiving the signal,
amplifying the RF component of the signal,
detecting the size of the DC component and providing an attenuation control signal,
attenuating the RF component of the signal to a level such that when the RF signal is transmitted it will be transmitted at the desired output level, and
transmitting the RF component of the signal.

11. The method according to claim 10, further comprising:
amplifying the RF component of the signal based on the value of the DC component such that the signal prior to attenuation is of a known power level.

12. The method according to claim 10, further comprising:
switching between a received mode and a transmission mode based on the presence of a signal to transmit.

13. A power injector for use in a system having a signal source, an amplifier, and cable, said power injector comprising:
an input in communication with the signal source,
an output in communication with the amplifier,
an actuator for selecting an output power level, and
a voltage regulator in communication with said output and said actuator, said voltage regulator has a plurality of selectable output power levels.

14. The power injector according to claim 13, wherein said actuator is a knob.

15. The power injector according to claim 13, further comprising
a capacitor connected to said input, and
an inductor connected between said voltage regulator and said input and said output.

16. An bi-directional amplifier in communication with a signal source and an antenna, said bi-directional amplifier comprising:
means for switching between receive and transmit modes,
means for setting the output power level of a transmission signal based on the voltage of the transmit signal and providing a control signal,
means for attenuating the transmit signal based in part on the control signal, and
means for amplification of a received signal.

17. The bi-directional amplifier according to claim 16, wherein the setting means includes
a plurality of comparators for determining the voltage of the transmit signal, and
a decoder connected to said comparators, said decoder outputs the control signal based on the input received from said comparators.

18. The bi-directional amplifier according to claim 16, further comprising means for normalizing the signal input into said attenuating means based on the voltage of the transmit signal, and
wherein said normalizing means attenuates the signal input in an amount proportional to the voltage level of the transmission signal received from a signal source.

19. A kit for use in a wireless transmission system comprising:
the bi-directional amplifier of claim 16, and
a power injector having means for setting a desired output level for the transmission signal.
